(19) United States
(12) Patent Application Publication
(10) Pub. No.: US 2017/0178508 A1
(43) Pub. Date: Jun. 22, 2017

(54) System Of Controlling Speed Of Vehicle By Collecting Information Of Vehicle And Intersection And Method Thereof

(71) Applicants: Inventec (Beijing) Electronics Technology Co., Ltd., Beijing (CN); Inventec Corporation, Taipei City (TW)

(72) Inventor: Chaucer Chiu, Taipei (TW)

(21) Appl. No.: 15/073,332

(22) Filed: Mar. 17, 2016

(30) Foreign Application Priority Data
Dec. 18, 2015 (CN) 201510961894.5

(51) Int. Cl. G08G 1/0967; G08G 1/096; G08G 1/095; G08G 1/052

(52) U.S. Cl. CPC G08G 1/096725; G08G 1/052; G08G 1/096; G08G 1/095

(57) ABSTRACT

A system of controlling a speed of a vehicle by collecting information of the vehicle and an intersection, and a method thereof are disclosed. In the system, the traffic light information of the intersection ahead of the vehicle can be received from the traffic server through the wireless communication technology, and after the current position and speed of the vehicle and the speed limit of the road section where the vehicle is driving are collected, based on the obtained data it is determined whether it is possible for the vehicle to directly pass through the intersection ahead, and the speed of the vehicle is then controlled based on a determination result. Therefore, the technical effect of controlling the vehicle to pass through the intersection smoothly, safely and efficiently can be achieved, so as to prevent the driver from getting impatient.

### CROSS-REFERENCE TO RELATED APPLICATION

This application claims the benefit of Chinese Patent Application No. 201510961894.5, filed Dec. 18, 2015.

### BACKGROUND OF THE INVENTION

Field of the Invention

The present invention relates to a system of controlling a speed of a vehicle and a method thereof, more particularly to a system of controlling the speed of the vehicle by collecting information of the vehicle and an intersection.

Description of the Related Art

Traffic signal timing of the intersection is designed to provide a safe and efficient traffic environment for passerby. The traffic signal timing designed defectively causes traffic accidents easily or makes the vehicle move and stop frequently between changes of traffic lights, which makes driving inefficient. For example, the traffic light of the intersection cannot provide countdown seconds of green light, so the driver cannot accelerate to pass through the intersection safely when the traffic light is about to change; alternatively, the driver may not brake to stop before a stop line safely because of excessive speed. Moreover, if failing to anticipate the change time of the traffic light of the intersection, the driver cannot adjust the speed of the vehicle, which may cause an excessive wait time of the vehicle and delay the vehicle, so that the goal of providing the vehicle to pass through multiple intersections smoothly and efficiently cannot be achieved, and driving comfort is also reduced.

Therefore, there must be a tradeoff between efficiency and safety in the design of the traffic signal timing. If smooth and efficient pass through the intersection is the top consideration of the design of the traffic signal timing, the drivers may drive vehicles too fast easily, and it easily causes danger or accidents; if safe pass through the intersection is the top consideration of the design of the traffic signal timing, the drivers may decelerate before the intersection, but the wait time at the intersection is increased easily, and the drivers may lose patience to wait and possibly violate traffic rules, which easily results in danger or accidents.

In conclusion, the conventional technology has a problem that the vehicle moves and stops frequently between the traffic lights to cause the driver's impatience, for a long time. What is need is to provide an improved technical solution to solve the problem.

### SUMMARY OF THE INVENTION

In order to solve the conventional technology problem that the vehicle moves and stops frequently between the traffic lights to cause the driver's impatience, the present disclosure provides a system of controlling a speed of the vehicle by collecting information of the vehicle and an intersection, and a method thereof

According to one exemplary embodiment of the present disclosure, the system includes a wireless communication module, an information collection module, a stop determination module and a speed control module. The wireless communication module is configured to receive a traffic light and its duration of the intersection ahead of the vehicle from a traffic server, by wireless communication technology. The information collection module is configured to obtain a current position and a speed of the vehicle, and a speed limit of a road section where the vehicle is driving. The stop determination module is configured to determine whether it is possible for the vehicle to directly pass through the intersection without stopping, based on the current position, the speed, the speed limit, the traffic light and the duration of the traffic light. The speed control module is configured to control the speed of the vehicle based on a determination result.

According to one exemplary embodiment of the present disclosure, the method includes following steps: from a traffic server, receiving a traffic light and its duration of the intersection ahead of the vehicle by wireless communication technology; obtaining a current position and a speed of the vehicle; obtaining a speed limit of a road section where the vehicle is driving; based on the current position, the speed, the speed limit, the traffic light and the duration of the traffic light, determining whether it is possible for the vehicle to pass through the intersection without stopping, and controlling the speed of the vehicle based on a determination result.

In conclusion, the difference between the technology of the present disclosure and the conventional technology is that in the disclosure the traffic light information of the intersection ahead of the vehicle can be received from the traffic server through the wireless communication technology, and after the current position and the speed of the vehicle and the speed limit of the road section where the vehicle is driving are collected, based on and obtained data it is determined whether it is possible for the vehicle to directly pass through the intersection ahead, and the speed of the vehicle is then controlled based on the determination result. Therefore, the technical effect of controlling the vehicle to pass through the intersection smoothly, safely and efficiently can be achieved.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a block diagram of a system of controlling a speed of a vehicle by collecting information of the vehicle and an intersection, in accordance with the present disclosure.

FIG. 2A is a flow chart of a method of controlling the speed of the vehicle by collecting the information of the vehicle and the intersection, in accordance with the present disclosure.

FIG. 2B is a flow chart of detail steps of the method of controlling the speed of the vehicle, in accordance with the present disclosure.

FIG. 2C is a flow chart of other method of controlling the speed of the vehicle by collecting the information of the vehicle and the intersection, in accordance with the present disclosure.

### DETAILED DESCRIPTION

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

In the present disclosure, a speed of a vehicle can be controlled at least based on current position and speed of the vehicle, traffic lights, a traffic light change sequence and traffic lights durations of an intersection ahead of the vehicle, and a speed limit of a road section where the vehicle is driving, so that the vehicle can directly pass through the intersection without stopping, or smoothly stop in the front of the intersection to wait for traffic light change.

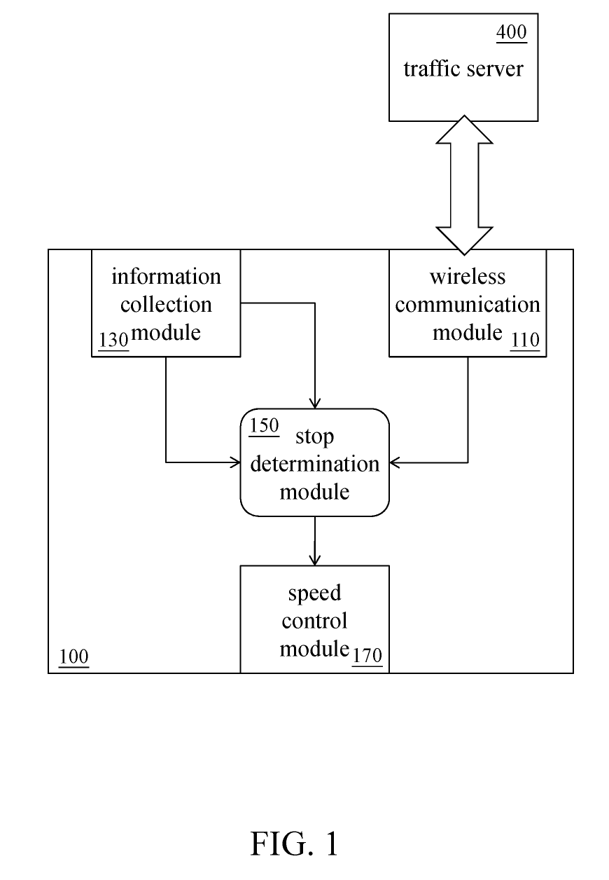

Please refer to FIG. 1 which shows a block diagram of a system of controlling a speed of a vehicle by collecting information of the vehicle and an intersection. An embodiment is taken as an example for illustrating the operation of the system of the present disclosure. As shown in FIG. 1, the system of the present invention is installed in a vehicle 100, and includes a wireless communication module 110, an information collection module 130, a stop determination module 150 and a speed control module 170.

The wireless communication module 110 is configured to interconnect with a traffic server 400 through wireless communication technology. Generally speaking, the wireless communication module 110 can apply the wireless communication technology such as 3G/4G network, WiFi/WiMax network, satellite communication network, Bluetooth or near field communication, to interconnect with the traffic server 400; however, the present invention is not limited thereto. In some embodiments, the traffic server 400 can be arranged in a machine room, or in a range from the intersection ahead of the vehicle 100; however, the present invention is not limited thereto.

The wireless communication module 110 is also configured to receive a current traffic light and its duration of the intersection ahead of the vehicle 100, from the traffic server 400. The wireless communication module 110 can also receive the current traffic light, sequence of all traffic lights, and durations of all traffic lights of the intersection ahead of the vehicle 100. In some embodiments, the wireless communication module 110 can further acquire a traffic condition of the intersection ahead of the vehicle 100. Generally speaking, the wireless communication module 110 sends requests to the traffic server 400, thereby receiving the current traffic light, the sequence of all traffic lights, the durations of the traffic lights, and the traffic condition of the intersection ahead of the vehicle 100, from the traffic server 400; however, the present invention is not limited thereto.

The information collection module 130 is configured to acquire a current position and speed of the vehicle 100. Generally speaking, the information collection module 130 can acquire the current position of the vehicle 100 through a positioning system installed on the vehicle 100. Preferably, the current position is longitude and latitude data. The information collection module 130 can also acquire the current speed of the vehicle 100 from an operation control system (not shown in figure) of the vehicle 100. However, the way used by the information collection module 130 to collect the current position and speed of the vehicle 100 is not limited to the above-mentioned embodiment.

The information collection module 130 is also configured to acquire the speed limit of a road section where the vehicle 100 is driving. The information collection module 130 can transmit the current position of the vehicle 100 to the traffic server 400 through the wireless communication module 110, thereby receiving the speed limit returned from the traffic server 400. The information collection module 130 can also compare the current position of the vehicle 100 with prebuilt data, thereby determining the speed limit of the current position of the vehicle 100. For example, some existing vehicle navigation products also implement the above-mentioned function. However, the way used by the information collection module 130 to obtain the speed limit of the road section where the vehicle 100 is driving, is not limited to the above-mentioned embodiment.

The stop determination module 150 is configured to determine whether it is possible for the vehicle 100 to pass through the intersection directly rather than stop before the intersection, according to the current position and speed of the vehicle 100 and the speed limit of the road section where the vehicle 100 is driving, which are obtained by the information collection module 130, and the current traffic light and its duration (or the current traffic light, the sequence of all traffic lights and durations of all traffic lights) of the intersection ahead of the vehicle 100, which are received by the wireless communication module 110. That is, the stop determination module 150 determines whether the traffic light of the intersection ahead of the vehicle 100 indicates that the vehicle 100 can pass or must stop to wait when reaching the intersection.

The stop determination module 150 can calculate a distance between the current position of the vehicle 100 and the intersection ahead of the vehicle 100 first, and then calculate a maximal time in which the vehicle 100 can pass through the intersection directly, based on the current traffic light and its duration of the intersection ahead of the vehicle 100 (or the current traffic light of the intersection ahead of the vehicle 100, the sequence of all traffic lights, and durations of all traffic lights), and then calculate a suggested speed based on the distance between the vehicle 100 and the intersection, the maximal time in which the vehicle 100 can pass the intersection, and the current speed of the vehicle 100, and then determine whether the suggested speed exceeds the speed limit of the current road section where the vehicle 100 is driving. When the suggested speed exceeds the speed limit, the stop determination module 150 determines that the vehicle 100 must stop before the intersection.

When the suggested speed does not exceed the speed limit, that is, smaller than or equal to the speed limit, the stop determination module 150 determines that the vehicle 100 can directly pass through the intersection rather than stop. However, the way used by the stop determination module 150 to determine whether it is possible for the vehicle 100 to directly pass through the intersection ahead rather than stop is not limited to the above-mentioned embodiment.

In some embodiments, the stop determination module 150 can also determine whether it is possible for the vehicle 100 to directly pass through the intersection ahead rather than stop, based on the current position and speed of the vehicle 100, the speed limit of the road section where the vehicle 100 is driving, the current traffic light and its duration of the intersection ahead of the vehicle 100 (or the current traffic light of the intersection ahead of the vehicle 100, the sequence of all traffic lights, and the durations of all traffic lights), and the traffic condition of the intersection ahead of the vehicle 100. For example, when the suggested speed calculated by the stop determination module 150 does not exceed the speed limit but the traffic condition of the intersection ahead of the vehicle 100 indicates excessive vehicles staying at the intersection, the stop determination module 150 can determine that the vehicle is hard to keep driving in the suggested speed to the intersection ahead, the stop determination module 150 can also determine that the vehicle 100 cannot pass through the intersection ahead without stopping first.

The speed control module 170 is configured to control the speed of the vehicle 100 based on a determination result generated by the stop determination module 150. Generally speaking, the speed control module 170 can control the speed of the vehicle 100 through the operation control system of the vehicle 100, but the present disclosure is not limited thereto.

When the stop determination module 150 determines that the vehicle 100 cannot directly pass through the intersection ahead without stopping first (that is, the vehicle 100 must be stopped before the intersection), the speed control module 170 controls the vehicle 100 to decelerate after the vehicle 100 is driving for a certain period, for a certain distance or to a certain location, as so to smoothly stop the vehicle 100 before the intersection rather than to brake late. When the stop determination module 150 determines that the vehicle 100 can directly pass through the intersection ahead, the speed control module 170 can control the vehicle 100 to keep driving in the same speed or accelerate to the suggested speed calculated by the stop determination module 150, thereby enabling the vehicle 100 to smoothly pass through the intersection ahead without stopping first, under a condition that the speed of the vehicle 100 does not exceed the speed limit of the road section where the vehicle 100 is driving.

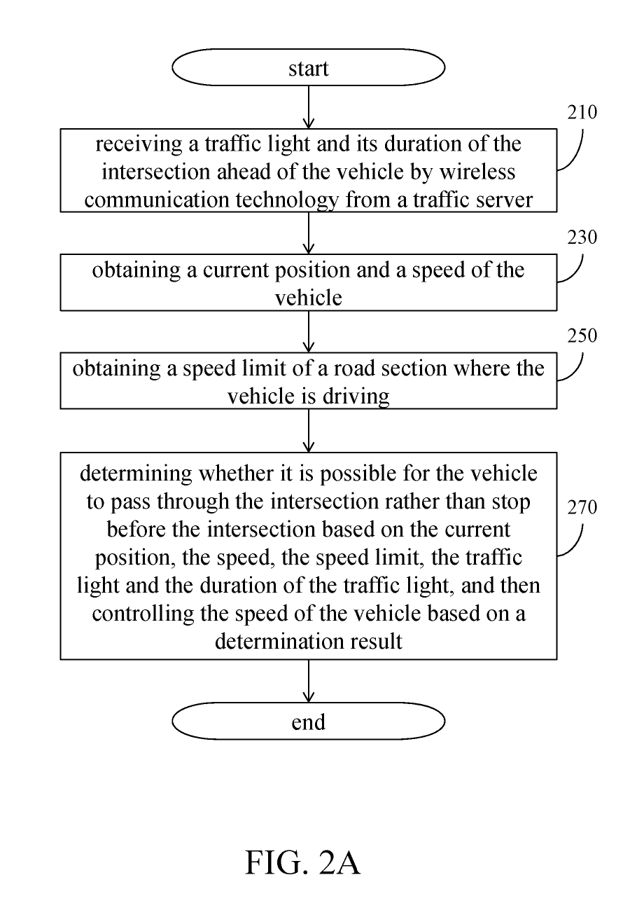

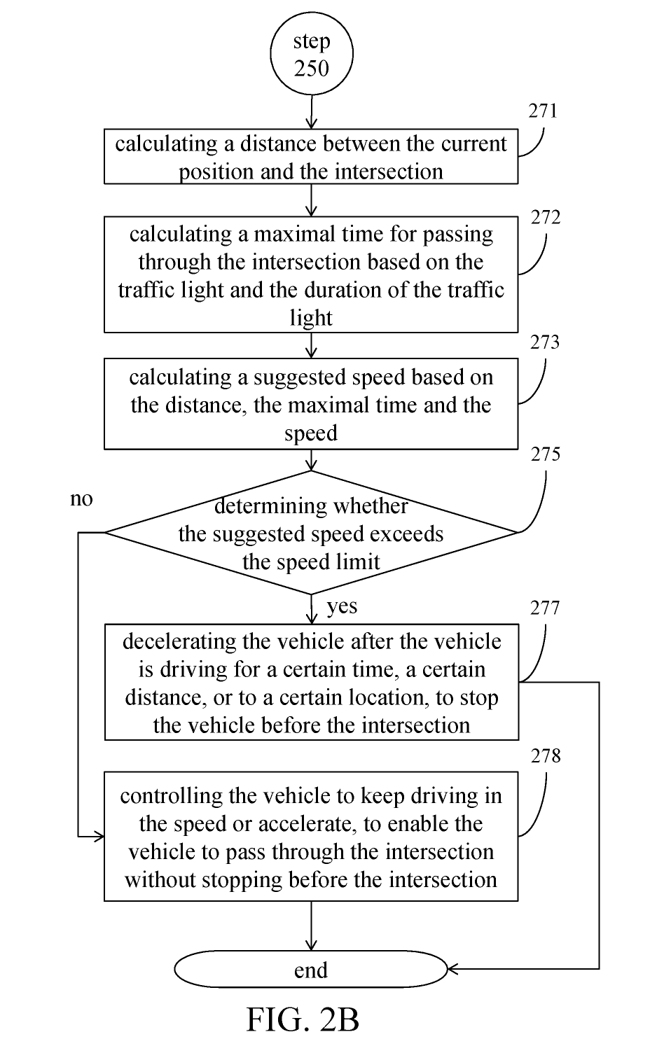

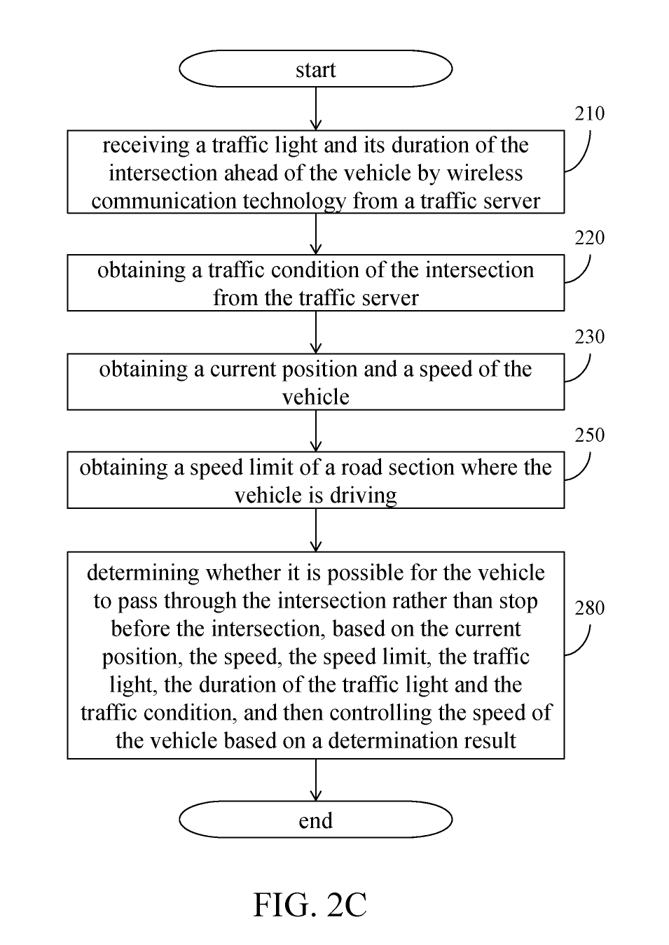

Please refer to FIG. 2A which shows a flow chart of the method of controlling the speed of the vehicle by collecting information of the vehicle and the intersection. An embodiment is taken as an example to explain the operation and method of the present disclosure. For example, in this embodiment, the method of the present disclosure is implemented in the operation control system of the vehicle 100, but the present disclosure is not limited thereto.

While the vehicle 100 is driving, the wireless communication module 110 can at least receive the information and duration of the current traffic light of the intersection ahead of the vehicle 100 from the traffic server 400 by the wireless communication technology (step 210). For example, in this embodiment the wireless communication module 110 can be interconnected with the traffic server 400 disposed at the intersection ahead by using the Adhoc mode of the Wi-Fi technology, and transmit a request to the traffic server 400 for the current traffic light, the sequence and durations of all traffic lights of the intersection ahead after the successful interconnection with the traffic server 400 disposed at the intersection ahead.

After the wireless communication module 110 receives the information and duration of the traffic light of the intersection ahead of the vehicle 100, the information collection module 130 can obtain the current position and speed of the vehicle 100 (step 230). For example, in this embodiment the information collection module 130 can obtain current longitude and latitude data (that is the current position) of the vehicle 100 from the satellite positioning module of the vehicle 100, and calculate the speed of the vehicle 100 based on two continuous sets of longitude and latitude data and a time period.

After the information collection module 130 obtains the current position and speed of the vehicle 100 (step 230), the information collection module 130 obtains the speed limit of the road section where the vehicle 100 is driving (step 250). For example, in this embodiment, the information collection module 130 can inquiry the traffic server 400 through the wireless communication module 110, and also inquiry the speed limit of the road section where the vehicle 100 is driving based on the current position of the vehicle 100, from a prebuilt database.

After the wireless communication module 110 receives the traffic light and its duration of the intersection ahead of the vehicle 100 (step 210) and the information collection module 130 obtains the current position and the speed of the vehicle 100, and the speed limit of the road section where the vehicle 100 is driving (steps 230 and 250), the stop determination module 150 determines whether it is possible for the vehicle 100 to pass through the intersection ahead rather than stop before the intersection, based on the current position and speed of the vehicle 100 obtained by the information collection module 130, the speed limit of the road section where the vehicle 100 is driving, and the traffic light and its duration of the intersection ahead of the vehicle 100 received by the wireless communication module 110 . The speed control module 170 then controls the speed of the vehicle 100 based on the determination result generated by the stop determination module 150 (step 270).

For example, in present embodiment, the operations of the stop determination module 150 and the speed control module 170 can be the same as the flow shown in FIG. 2B, the stop determination module 150 first calculates the current position of the vehicle 100 and the distance between the vehicle 100 and the intersection ahead (step 271). For example, in present embodiment, the stop determination module 150 can search the position data of the intersection ahead of the vehicle 100 from a prebuilt road database based on the current position of the vehicle 100 collected by the information collection module 130, and then calculate the distance based on the current position of the vehicle 100 and the searched position data of the intersection ahead.

The stop determination module 150 can also calculate the maximal time for passing the intersection ahead based on the traffic light and its duration of the intersection (step 272). In present embodiment, the stop determination module 150 can calculate the maximal time based on the current traffic light, the traffic light change sequence, and durations of traffic lights of the intersection ahead received by the wireless communication module 110. For example, when the current traffic light of the intersection ahead is green and the duration of the green light is 28 seconds, the stop determination module 150 calculates the maximal time is 28 seconds. If the current traffic light of the intersection ahead is yellow, and the traffic light change sequence is green light, yellow light, red light and green light, and the durations of the yellow, green and red lights are respectively 3 seconds, 77 seconds and 69 seconds, the maximal time calculated by the stop determination module is 149 (3+69+77) seconds.

After the stop determination module 150 calculates the distance between the current position of the vehicle 100 and the intersection ahead and the maximal time for passing through the intersection ahead, the stop determination module 150 then calculates the suggested speed based on the distance, the maximal time, the current speed of the vehicle 100 collected by the information collection module 130 (step 273). For example, in present embodiment, the stop determination module 150 can calculate a reference speed based on the distance and the maximal time, and then fine tune the reference speed to generate the suggest speed based on difference between the current speed of the vehicle 100 and the reference speed. For example, the stop determination module 150 may extra calculate a time period required for accelerating the vehicle 100 from the current speed to the reference speed, and then fine tune the reference speed based on the time period.

After calculating the suggested speed, the stop determination module 150 determines whether the suggested speed exceeds the speed limit of the road section where the vehicle 100 is driving (step 275). The speed limit is collected by the information collection module 130. When the suggested speed exceeds the speed limit, the speed control module 170 starts to decelerate the vehicle 100 after the vehicle 100 is driving for a certain time, for a certain distance, or to a certain location, so as to stop the vehicle 100 before the intersection (step 277). If the suggested speed does not exceed the speed limit, the speed control module 170 controls the vehicle to keep driving in the current speed or accelerate to the suggested speed, so as to enable the vehicle 100 to directly pass through the intersection ahead without stopping before the intersection (step 278).

Therefore, by means of the technology of the present disclosure, the vehicle 100 can smoothly and efficiently pass through the intersection ahead, so as to prevent the driver of the vehicle 100 from running the yellow light to cause danger.

In addition, the above-mentioned embodiment can also be implemented as the flow shown in FIG. 2C. While receiving the current traffic light and its duration of the intersection ahead of the vehicle 100 from the traffic server 400 through the wireless communication technology (step 210), the wireless communication module 110 also receives a traffic condition of the intersection ahead of the vehicle 100 from the traffic server 400 (step 220).

After the information collection module 130 obtains the current position and speed of the vehicle 100 (step 230) and the speed limit of the road section where the vehicle 100 is driving (step 250), the stop determination module 150 determines whether it is possible for the vehicle 100 to pass through the intersection ahead rather than stop before the intersection, based on the current position and speed of the vehicle 100 collected by the information collection module 130, the speed limit of the road section where the vehicle 100 is driving, and the current traffic light, its duration and the traffic condition of the intersection ahead of the vehicle 100 received by the wireless communication module 110, and the speed control module 170 then controls the speed of the vehicle 100 based on the determination result generated by the stop determination module 150 (step 280). For example, if there are excessive vehicles waiting for passing the intersection ahead, it means that all waiting vehicles cannot pass the intersection in a traffic light change duration, the stop determination module 150 determines that the vehicle 100 cannot directly pass through the intersection ahead, and the speed control module 170 can calculate the suggested speed for the vehicle 100 based on the current position and speed of the vehicle 100, and an anticipated stop location of the vehicle 100, thereby controlling the vehicle 100 to stably stop before the intersection ahead to wait for change of the traffic light.

In conclusion, the difference between the technology of the present disclosure and the conventional technology is that in the system and method of the present disclosure the traffic light information of the intersection ahead of the vehicle can be received from the traffic server through the wireless communication technology, and after the current position and the speed of the vehicle and the speed limit of the road section where the vehicle is driving are collected, based on and obtained data it is determined whether the vehicle can directly pass through the intersection ahead, and the speed of the vehicle is controlled based on the determination result. Therefore, the technology of the present disclosure can solve the problem that the vehicle moves and stops frequently between the traffic lights to make the driver get impatient, so as to achieve the technical effect of controlling the vehicle to pass through the intersection smoothly, safely and efficiently.

Moreover, the method and system of controlling the speed of the vehicle by collecting the information of vehicle and intersection can be implemented by hardware, software or a combination thereof, or a centralization manner in a computer system, or a distributive manner where different devices are distributed in different computer systems interconnected with each other.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A method of controlling a speed of a vehicle by collecting information of the vehicle and an intersection, comprising:
receiving a traffic light and a duration of the traffic light of the intersection ahead of the vehicle by wireless communication technology from a traffic server;
obtaining a current position and a speed of the vehicle;
obtaining a speed limit of a road section where the vehicle is driving; and
determining whether it is possible for the vehicle to pass through the intersection rather than stop before the intersection based on the current position, the speed, the speed limit, the traffic light and the duration of the traffic light, and controlling the speed of the vehicle based on a determination result.

2. The method according to claim 1, wherein the step of controlling the speed of the vehicle based on the determination result, further comprises:
decelerating the vehicle after the vehicle is driving for a certain time, a certain distance, or to a certain location, to stop the vehicle before the intersection.

3. The method according to claim 1, wherein the step of controlling the speed of the vehicle based on the determination result, further comprises:
controlling the vehicle to keep driving in the speed or accelerate, to enable the vehicle to pass through the intersection without stopping before the intersection, under a condition that the speed of the vehicle does not exceed the speed limit.

4. The method according to claim 1, wherein the step of determining whether it is possible for the vehicle to pass through the intersection rather than stop before the intersection based on the current position, the speed, the speed limit, the traffic light and the duration of the traffic light, further comprises:
calculating a distance between the current position and the intersection;
calculating a maximal time for passing through the intersection based on the traffic light and the duration of the traffic light;
calculating a suggested speed based on the distance, the maximal time and the speed; and
determining whether the suggested speed exceeds the speed limit.

5. The method according to claim 1, before the step of determining whether it is possible for the vehicle to pass through the intersection rather than stop before the intersection based on the current position, the speed, the speed limit, the traffic light and the duration of the traffic light, further comprising:
obtaining a traffic condition of the intersection from the traffic server;
determining whether it is possible for the vehicle to pass through the intersection rather than stop before the intersection, based on the current position, the speed, the speed limit, the traffic light, the duration of the traffic light and the traffic condition.

6. A system of controlling a speed of a vehicle by collecting information of a vehicle and an intersection, and the system comprising:
a wireless communication module receiving a traffic light and a duration of the traffic light of the intersection ahead of the vehicle by wireless communication technology from a traffic server;
an information collection module obtaining a current position and the speed of the vehicle, and a speed limit of a road section where the vehicle is driving;
a stop determination module determining whether the vehicle directly pass through the intersection without stopping, based on the current position, the speed, the speed limit, the traffic light and the duration of the traffic light; and
a speed control module configured to control the speed of the vehicle based on a determination result.

7. The system according to claim 6, wherein the speed control module decelerates the vehicle after the vehicle is driving for a certain time, a certain distance, or to a certain location, so as to stop the vehicle before the intersection.

8. The system according to claim 6, wherein the speed control module controls the vehicle to keep driving in the speed or accelerate, so as to enable the vehicle to pass through the intersection without stopping before the intersection, under a condition that the speed of the vehicle does not exceed the speed limit.

9. The system according to claim 6, wherein the stop determination module calculates a distance between the current position and the intersection, and calculates a maximal time for passing the intersection based on the traffic light and the duration of the traffic light, and calculates a suggested speed based on the distance, the maximal time and the speed, and then determines whether the suggested speed exceeds the speed limit.

10. The system according to claim 6, wherein the wireless communication module further obtains a traffic condition from the traffic server, and the stop determination module determines whether it is possible for the vehicle to pass through the intersection rather than stop before the intersection, based on the current position, the speed, the speed limit, the traffic light, the duration of the traffic light and the traffic condition.
